(19) United States
(12) Patent Application Publication
(10) Pub. No.: US 2023/0336504 A1
(43) Pub. Date: Oct. 19, 2023

(54) Multimode Conversational Agent using a Pattern-Completion Engine

(71) Applicant: Microsoft Technology Licensing, LLC, Redmond, WA (US)

(72) Inventors: Christian Alexander COSGROVE, Stanford, CA (US); Saurabh Kumar TIWARY, Bellevue, WA (US)

(73) Assignee: Microsoft Technology Licensing, LLC, Redmond, WA (US)

(21) Appl. No.: 17/721,703

(22) Filed: Apr. 15, 2022

(51) Int. Cl. H04L 51/02; G06N 3/08; G06N 5/02; G06F 9/46

(52) U.S. Cl. CPC H04L 51/02; G06N 3/08; G06N 5/02; G06F 9/461

(57) ABSTRACT

A computer-implemented technique is described herein for providing assistance to a user in performing various computer-related tasks. The technique relies on a state machine system that transitions among plural modes based on mode-specific cues provided by a pattern-completion engine. The pattern-completion engine, in turn, is induced to generate these cues based on initial context information provided to a context store of the state machine system. Among other information, the initial context information provides example dialogues that are annotated with mode-specific cues. Throughout its operation, the technique updates context information provided in the context store. The plural modes can include at least a user mode, an answer mode, and a command mode. The technique also provides various mechanisms to ensure the privacy of sensitive-information items and to reduce the risk that commands will damage execution platforms.

### BACKGROUND

An automated conversational agent is traditionally built using one or more machine-trained models. A developer trains each machine-trained model to perform a prescribed task, such as determining the intent of the user's inquiry, determining the topics to which the user's inquiry pertains, and generating an appropriate response to the user's inquiry. A conversational agent may also use a manually-created state transition table that defines the rules that govern how the conversational agent transitions from one operational state to another. While existing conversational agents have enjoyed considerable commercial success, there remains room for improvement in this field of technology. For instance, a developer may devote a significant amount of effort in developing and maintaining custom functionality for use in a conversational agent. In addition, the developer may find it necessary to retrain and/or re-design the functionality when the functionality is applied to a new problem domain. These drawbacks impede the efficient evolution and upkeep of conversational agents, and can potentially compromise their accuracy and flexibility. In other words, the above approach does not provide a scalable solution to the development of conversational agents.

### SUMMARY

According to illustrative implementations, a computer-implemented technique is described herein that provides assistance to a user in performing different kinds of computer-related tasks. The technique relies on a state machine system that transitions among plural modes based on mode-specific cues provided by a pattern-completion engine. The pattern-completion engine, in turn, is induced to generate these cues based on initial context information provided to a context store of the state machine system. Among other information, the initial context information provides example dialogues that have been annotated with mode-specific cues. Throughout the system machine's operation, the state machine system updates the context information provided in the context store.

In some implementations, the plural modes include at least a user mode, an answer mode, and a command mode. The user mode is configured to receive input from the user. The answer mode is configured to interact with the pattern-completion engine to determine an answer, based on current context information in the context store. The command mode is configured to interact with the pattern-completion engine to determine a command, based on the current context information in the context store, and to execute the command on an execution platform.

In some implementations, the pattern-completion engine uses a transformer-based decoder that auto-repressively generates tokens.

In some implementations, the technique includes various safety provisions to protect the undesired release of sensitive-information items, and to reduce the risk of harm caused by the execution of commands.

The technique has various technical merits. For example, the technique provides a way of harnessing the power of a pattern-completion engine to provide assistance to users, without the labor-intensive, error-prone, and expensive process of developing custom machine-trained models and handcrafted transition tables. For instance, the technique can be reconfigured to provide assistance in a new application environment by adjusting the initial context information that is fed to the state machine system, rather than producing a new machine-trained model. In other implementations, however, the technique can optionally fine-tune a base model to increase the base model's usefulness to the state machine system. For example, the technique can fine-tune the base model to reduce the likelihood that the base model will produce commands that will cause damage to a user's computing device. The technique can also use isolation mechanisms that allow a user to quickly and safely generate and execute commands without causing harm to an execution platform.

The above-summarized technology can be manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative agent system that includes a state machine system that interacts with a pattern-completion engine.

FIG. 2 shows additional details regarding one implementation of the state machine system of FIG. 1.

FIG. 3 shows one implementation of a user mode component, which is one element of the state machine system of FIG. 2.

FIG. 4 shows one implementation of an answer mode component, which is another element of the state machine system of FIG. 2.

FIG. 5 shows one implementation of a command mode component, which is another element of the state machine system of FIG. 2.

FIG. 6 shows an example of a dialogue between a user and the agent system of FIG. 1.

FIG. 7 shows signals produced by the agent system of FIG. 1 for the dialogue of FIG. 6.

FIGS. 8-11 respectively show four other examples of dialogues between a user and the agent system of FIG. 1.

FIGS. 12 and 13 together show illustrative initial context information that can be fed to the state machine system of FIG. 1, which induces desired behavior in the pattern-completion engine.

FIG. 14 shows a transformer-based decoder, which is one model that can be used to implement the pattern-generation engine in the agent system of FIG. 1.

FIG. 15 shows one technique for training a code-language model for use in the pattern-completion engine of FIG. 1.

FIG. 16 shows another technique for training a code-language model for use in the pattern-completion engine of FIG. 1.

FIG. 17 is a flowchart that summarizes one manner of operation of the agent system of FIG. 1.

FIG. 18 is a flowchart that summarizes one manner of operation of the command mode component of FIG. 5.

FIG. 19 shows computing equipment that can be used to implement the agent system shown in FIG. 1 and the training systems of FIGS. 15 and 16.

FIG. 20 shows an illustrative type of computing system that can be used to implement any aspect of the features shown in the foregoing drawings.

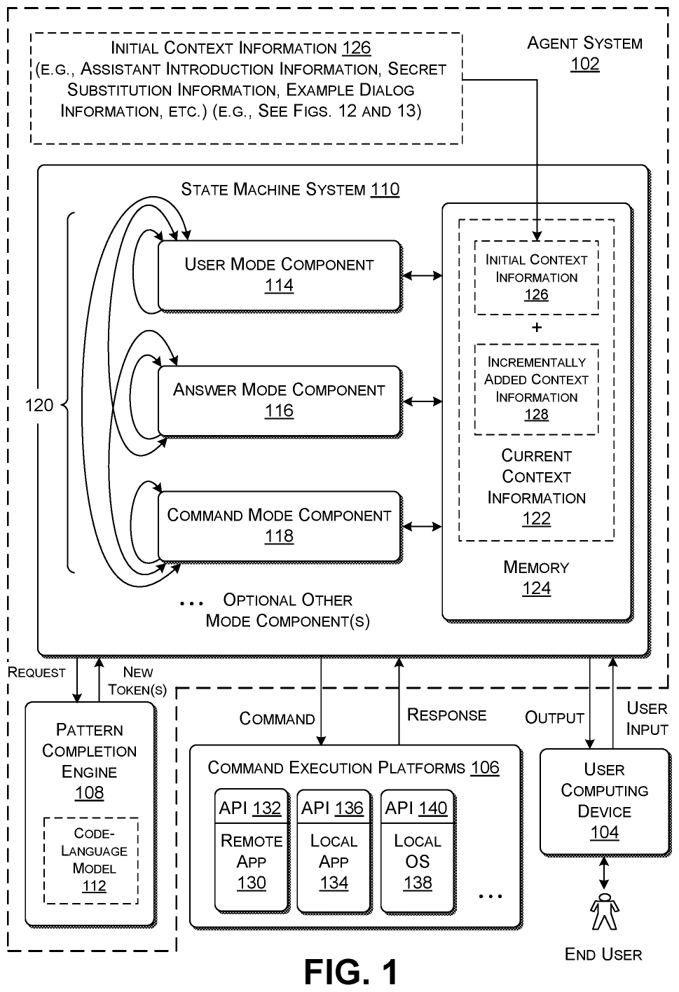

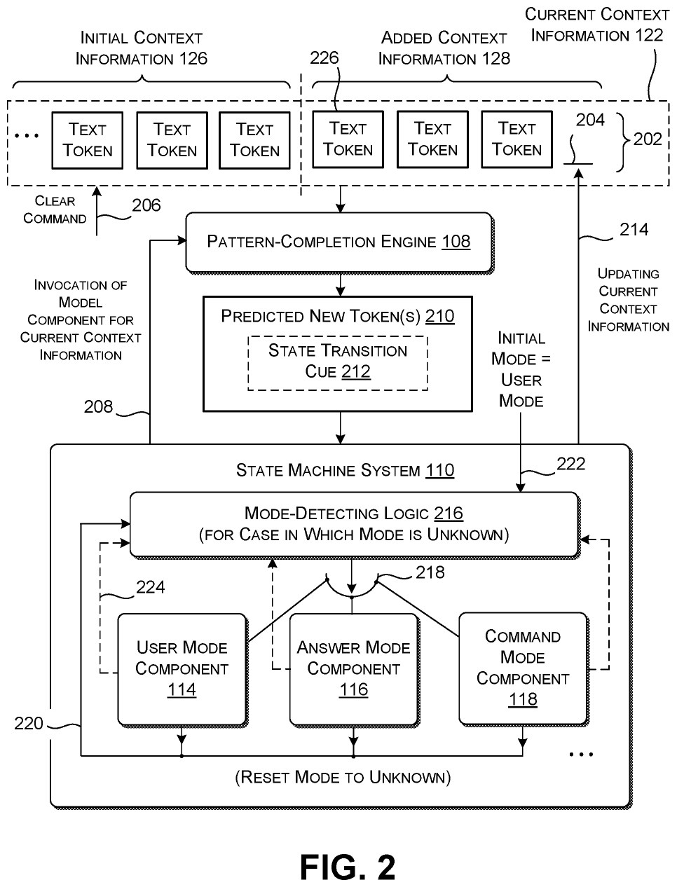

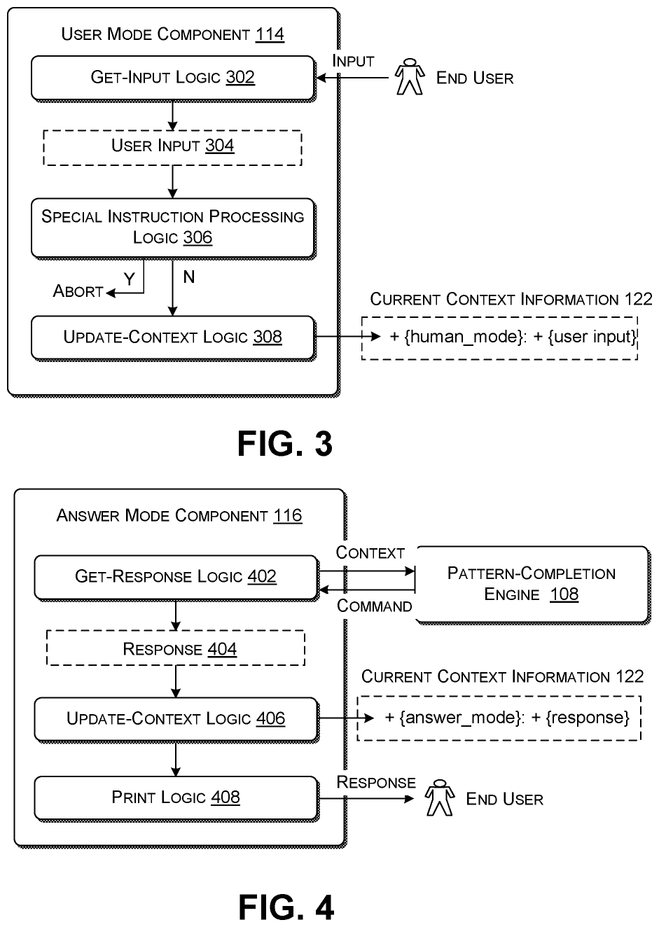

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes an illustrative agent system for assisting a user in performing tasks. Section B sets forth illustrative methods that explain the operation of the agent system of Section A. And Section C describes illustrative computing functionality that can be used to implement any aspect of the features described in Sections A and B.

A. Illustrative Systems

FIG. 1 shows an illustrative agent system 102 for assisting a user in performing different kinds of tasks. The user interacts with the agent system 102 using a user computing device 104 of any type, such as desktop computing device, a handheld computing device (e.g., a smartphone, etc.), and so on. In some contexts, the agent system 102 generates at least one command for execution on one or more command execution platforms 106 (referred to as “execution platforms” below for brevity). The execution platforms 106 can include software running on one or more remote servers and/or one or more local computing devices (where “remote” and “local” are used with reference to a present location of the user). For example, the agent system 102 can produce a command to extract information from a remote knowledge base. In another case, the agent system 102 can produce a command that adds an item to a local file stored by the user computing device 104. In other contexts, the agent system 102 engages in a conversation with the user without necessarily generating and executing any commands. The following explanation will provide many other examples of the kinds of dialogues supported by the agent system 102. In general, the agent system 102 can be characterized as a universal service because the agent system 102 can perform many different tasks in cooperation with many different execution platforms 106, and is not narrowly tailored to specific problem domains or specific applications.

The agent system 102 includes two main components: a pattern-completion engine 108 and a state machine system 110. The pattern-completion engine 108 accepts a sequence of text tokens, and, based thereon, predicts a text token that is most likely to follow the sequence of text tokens. For example, given the incomplete fragment “The dog wouldn't know what to do if it,” the pattern-completion engine 108 can predict that the text token that is most likely to follow “it” is “caught.” In a subsequence prediction cycle, the pattern-completion engine 108 adds the word “caught” to the end of the previous sequence to produce “the dog wouldn't know what to do if it caught.” The pattern-completion engine 108 may next predict that the word “the” is most likely to follow “caught.” The pattern-completion engine 108 can continue this process until the pattern-completion engine 108 generates an end-of-sequence token, which designates the likely end to the sequence of text tokens. This mode of operation is generally referred to in the technical literature as auto-regression.

In some implementations, the pattern-completion engine 108 is implemented using a code-language model 112. As used herein, a code-language model refers to any type of machine-trained model that has been trained on at least a corpus of ordinary natural language training examples and a corpus of code training examples. For example, the ordinary natural language training examples can be drawn from any online and/or offline source(s), such as articles, books, web page content, social media posts, product reviews, prior dialogue examples, and so on. The code training examples can be drawn from any repository of code samples, such as program examples posted on the website GitHub, hosted by GitHub, Inc. of San Francisco, California, the parent organization of which is Microsoft Corporation of Redmond, Washington.

While the code-language model 112 operates in cooperation with the state machine system 110, it is instructive to first explain its behavior when considered as a standalone module. In some contexts, a user can feed the code-language model 112 a fragment of computer code. In response, the code-language model 112 auto-completes the fragment, to provide one or more completed lines of program code, or perhaps an entire program. In other contexts, a user can feed the code-language model 112 a high-level description of a programming objective, e.g., prefaced by a telltale comment character (such as the “#” character in the Python programming language). In response, the code-language model 112 generates one or more lines of completed program code, or perhaps an entire program. The code-language model 112 can perform the latter auto-completion task because it has been produced by a training system that has learned the textual relationship between comments and program instructions that appear in program fragments in the code training examples. In still other contexts, a user can enter ordinary text to the code-language model 112 that contains no telltale content to indicate that it pertains to program content. For instance, the ordinary text may correspond to a fragment of a natural language sentence used to convey information from one human to another. The code-language model 112 may complete the ordinary text by adding more ordinary text until a stop character is encountered.

At its core, the code-language model 112 is agnostic to the type of input information that is fed to it. The input is simply a sequence of text tokens, and the code-language model 112 will attempt to successively find a text token that is most likely to follow the input sequence. Note, however, that the code-language model 112 does not perform auto-completion by drawing from prior training examples in rote fashion. Rather, through its training, the code-language model 112 generalizes the knowledge imparted by all of its training examples. This enables the code-language model 112 to successfully complete a text fragment even though it has never encountered its complete counterpart in its training set. For instance, a training set may have including some examples that establish that A=B, some examples that establish B=C, and still other examples that generally demonstrate the use of syllogistic reasoning. The code-language model 112 may therefore have the ability to complete a sentence based on the insight that A=C, even though there are no training examples in the training set that explicitly make this association. More specifically, a training system learns this kind of relationship by mapping the text items associated with A, B, and C into respective distributed vectors in a semantic vector space, and learning the relations among these vectors in the vector space.

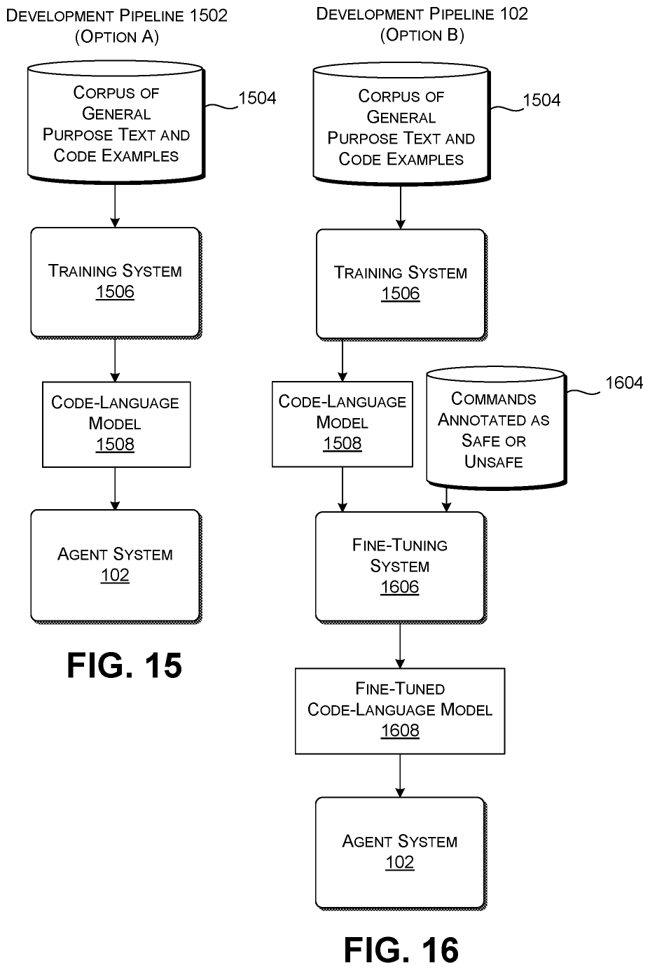

In some implementations, a training system may produce the code-language model 112 as standalone functionality that can be used in plural systems, without necessary reference to its specific use in the agent system 102 described herein. FIG. 15, to be described below, provides details regarding these implementations. In other implementations, the code-language model 112 can be adapted for use in conjunction with the state machine system 110. For example, a first training system can produce a general-purpose code-language model, and then a second training system can perform fine-tuning on the general-purpose code-language model to adapt it for use with the agent system 102, to produce a fine-tuned code-language model. For instance, the second training system can provide a corpus of computer commands that are variously labeled as safe or unsafe, depending on the risk they pose to an execution platform upon their execution. The second training system can fine-tune the general-purpose code-language model to reduce the likelihood that the fine-tuned code-language model will generate program code that is unsafe. General reference below to the code-language model 112 may refer to the type of code-language model produced using either of the development pipelines summarized above, or may be produced via yet some other development pipeline.

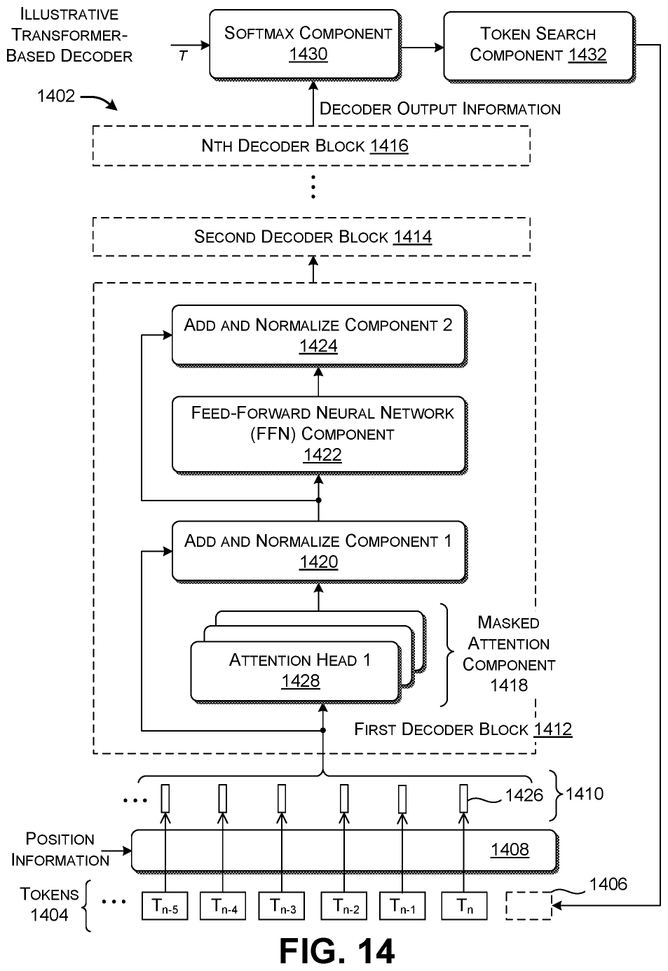

Different implementations can use different model architectures to build the pattern-completion engine 108. For example, the pattern-completion engine 108 can be implemented as a transformer-based decoder, one example of which is described below with reference to FIG. 14. In another case, the pattern-completion engine 108 can be implemented as a recurrent neural network (RNN) of any type, e.g., implemented by recursively calling a long short-term memory unit (LSTM), a gated recurrent unit (GRU), etc. The RNN can be trained using a generative adversarial network (GAN), or by some other training technique

The state machine system 110 is configured to transition among plural modes based, in part, on transition cues provided in engine output information generated by the pattern-completion engine 108. Each transition cue constitutes mode-identifying information that designates a target mode. For example, the state machine system 110 interprets the text represented by “{human_mode}:” as a transition cue to move to a user mode. The state machine system 110 interprets the text represented by “{answer_mode}:” as a transition cue to move to an answer mode. The state machine system 110 interprets the text represented by “{command_mode}:” as a transition cue to move to a command mode. More generally, in some non-limiting implementations, the state machine system 110 interprets the colon character “:” as an indication that some type of transition cue has been produced. Upon detecting a transition cue, the state machine system 110 transitions to the particular mode associated with the transition cue, and then performs one or more actions associated with that mode. For example, upon detecting the transition cue “{answer_mode}:” in the output information generated by the pattern-completion engine 108, the state machine system 110 transitions to the answer mode.

Further note that each instance of text included in each pair of curly brackets { . . . } is a placeholder string that an implementation can replace with an environment-specific string. For example, the placeholder string “{human_mode}” can be replaced with “User,” the placeholder string “{answer_mode}” can be replaced by “Alfie” (an arbitrary name given to the agent system 102), and the placeholder string {command_mode}” can be replaced by “Command.” This means that the text items “User:”, “Alfie:” and “Command:” are the actual transition cues fed to (and generated by) the pattern-completion engine 108.

FIG. 1 shows that the state machine system 110 includes three mode components (114, 116, 118) that handle actions in three respective modes. That is, a user mode component 114 performs actions in the user mode. These actions include receiving input from the user. The input may describe a request made by the user, a user command, a comment, etc. An answer mode component 116 performs actions in the answer mode. These actions include displaying or audibly reading out output information generated by the agent system 102 for consumption by the user. A command mode component 118 performs actions in the command mode. These actions involve generating a computer command, and optionally executing the computer command on an execution platform. FIG. 1 shows a set of transitions 120 that indicate that the state machine system 110 can transition from any given mode to any other mode, or back to the same given mode. The specific modes summarized above are to be understood as non-limiting examples; other implementations of the state machine system 110 can include additional mode components not shown in FIG. 1, and/or can omit one or more mode components shown in FIG. 1.

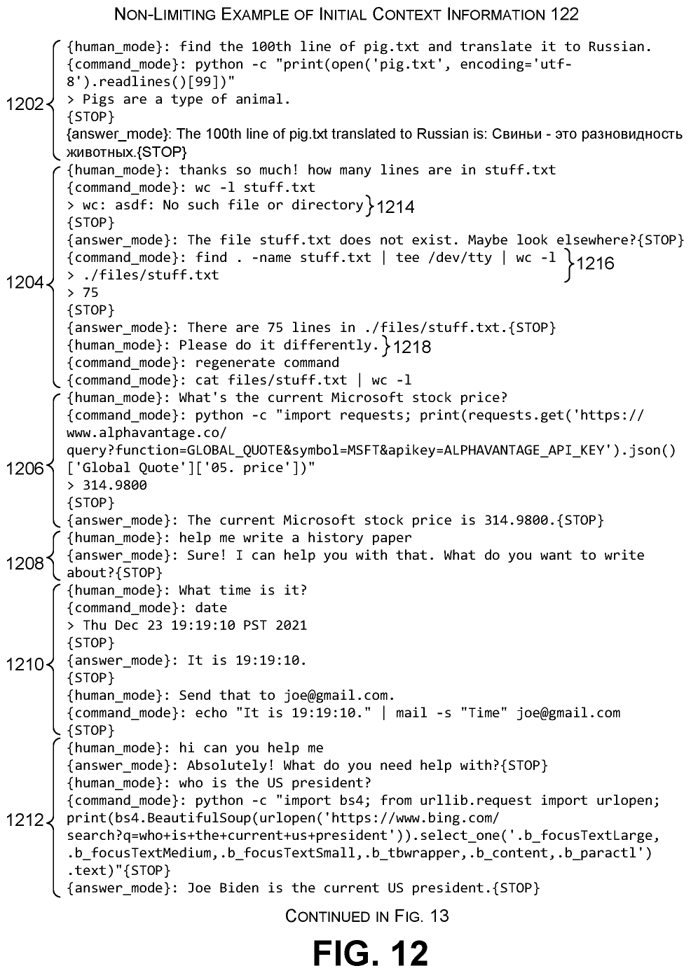

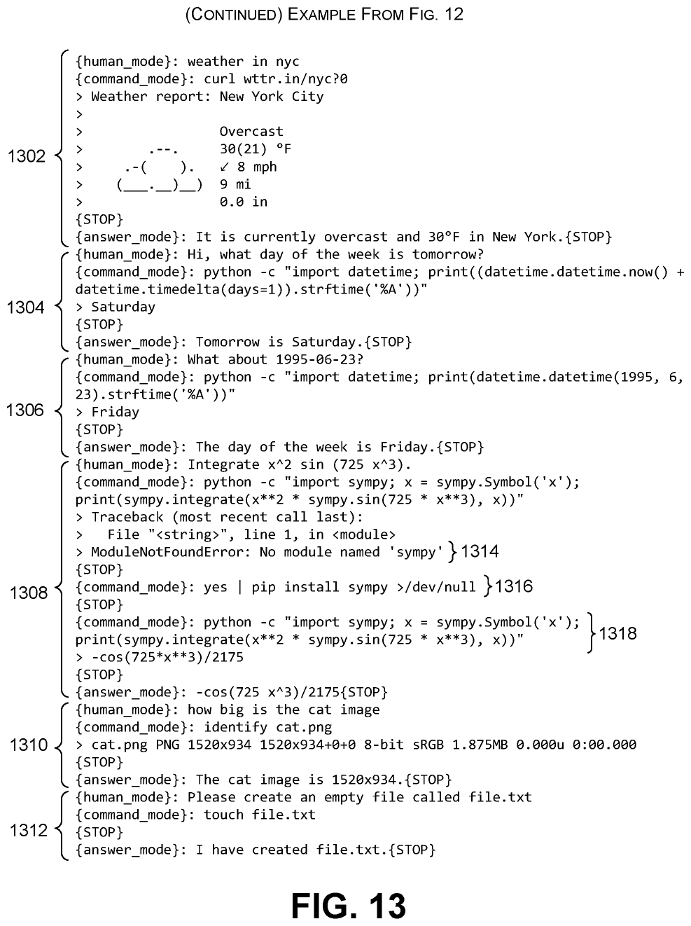

The state machine system 110 performs various complementary tasks that support the above manner of operation. In one such complementary task, the state machine system 110 maintains current context information 122 in a memory 124 (also referred to as a “context store” herein). At any given time, the current context information 122 describes the current sequence of text tokens that make up a current state of an in-progress dialogue. The sequence of text tokens that makes up the current context information 122, in turn, has two subsequences. A first subsequence of tokens constitutes initial context information 126, while a second subsequence of tokens constitutes added context information 128. The initial context information 126 includes pre-generated example dialogues and other prefatory text content that is fed to the memory 124 at the start of a dialog session. An example of the initial context information 126 will be described in greater detail below with reference to FIGS. 12 and 13. By contrast, the added context information 128 includes a series of text tokens produced in the course of a current dialogue session between the agent system 102 and the user. For example, the added context information 128 can include text tokens input by the user, text tokens generated by the pattern-completion engine 108, and text tokens that reflect results generated by the execution platforms 106.

From a high-level standpoint, the state machine system 110 relies on the initial context information 126 to establish a pattern of text content. In the course of interaction with the user, the state machine system 110, in conjunction with the pattern-completion engine 108, successively produce tokens of the added context information 128 in an attempt to extend the pattern of text content in the initial context information 126. For example, the initial context information 126 is seeded with particular kinds of transition cues (e.g., “{human_mode: }”, “{answer_mode}:”, “{command_mode}:”, etc.) that designate transitions among the above-described modes. (To repeat, “human_mode,” “answer_mode,” and “command_mode” are placeholder strings that are replaced with environment-specific text items, such as “User,” “Alfie,” and “Command”). Based on this guidance, the state machine system 110, in conjunction with the pattern-completion engine 108, is induced to produce these same transition cues at appropriate junctures in a sequence of text content. Generally, a model's reliance on prefatory content can be referred to as in-context learning. The learning is “in-context” because it happens at inference time, not training time. The model is said to specifically use “few-shot” in-context learning when the prefatory content includes plural teaching examples.

The state machine system 110 further promotes the above pattern extension behavior by actively injecting appropriate transition cues into the current context information 122. For example, in the user mode, the user mode component 114 can receive a sequence of text tokens that a user types via a keyboard, or speaks into a speech recognition component (not shown in FIG. 1). Assume that the user's input includes the question, “Is Joe Biden the oldest U.S. President?” The state machine system 110 will add this sequence of text tokens to the end of the sequence of text tokens in the current context information 122, preceded by the telltale cue “User:”, in which “User” is the actual text item that replaces the placeholder string “{human_mode }”

Continuing with the above example, in a next cycle, the state machine system 110 can use mode-detecting logic (described below) to feed the current context information 122 to the pattern-completion engine 108. This causes the pattern-completion engine 108 to generate the telltale transition cue “{answer_mode}:” (e.g., “Alfie:”). The mode-detecting logic detects this transition cue and activates the answer mode component 116 to obtain and process the agent system's answer (e.g., the response, “Yes, Joe Biden is the oldest president of the United States to be sworn into office”). In summary, the state machine system 110 induces the pattern-completion engine 108 to consistently extend a particular text pattern in two ways: first by preconditioning the current context information 122 with the initial context information 126, and second by injecting the same types of transition cues found in the initial context information 126 into the added context information 128.

To repeat, the command execution platforms 106 can include a wide assortment of execution environments that can carry out commands generated by the agent system 102. One kind of execution platform is a remote application 130 that is hosted by one or more severs (where the servers are “remote” with respect to a location of the user who interacts with the agent system 102 via the user computing device 104). Entities can interact with the remote application 130 via an application programming interface (API) 132. For example, the remote application 130 may correspond to a search engine that allows external entities to interact with some of the remote application's functionality using an API associated with that functionality. Another kind of execution platform is a local application 134 that is implemented by one or more computing devices that are local with respect to the location of the user. For instance, the computing device that implements the local application 134 may correspond to the user computing device 104 itself. Entities can interact with the local application 134 via an API 136. Another kind of execution platform is an operating system (OS) 138 of one or more local computing devices. For instance, the computing device that implements the OS 138 may correspond to the user computing device 104 itself. Entities can interact with the operating system 138 via an API 140.

The pattern-completion engine 108 can automatically generate code that allows the agent system 102 to interact with different applications that use different respective APIs. The pattern-completion engine 108 has this capability because the pattern completion engine 108 has been trained on program examples that demonstrate how to perform different functions by accessing different providers of those functions. For example, assume that a corpus of program fragments includes many examples that involve accessing an online map-related service through an API provided by the map-related service. When a user makes a request that pertains to a map-related function (such as by inquiring about the distance between two cities), the pattern-completion engine 108 can leverage its knowledge to craft a program statement that involves interacting with the map-related service's API. As noted above, the pattern-completion engine 108 is also capable of generalizing the examples in its training set, allowing it to provide viable program code even though it has never encountered a literal counterpart of that code in its training set.

The agent system 102 provides various technical benefits. For instance, in some implementations, the agent system 102 does not rely on custom machine-trained models that are configured to operate in certain problem domains. Nor does the agent system 102 involve the use of manually-generated transition tables that define how to transition among different operational states. Rather, the agent system 102 uses the state machine system 110 to induce a domain-agnostic pattern-completion engine 108 to adhere to a particular structure of interaction among multiple modes. That structure is defined by the initial context information 126 and is enforced by the state machine system 110. The developer can adjust the operation of the agent system 102 by performing the comparatively “light” modification to the control logic of the state machine system 110, rather than developing a whole new machine-trained model, or modifying an existing machine-trained model. This ability facilitates both the development and maintenance of the agent system 102, compared to traditional systems that rely on domain-specific custom functionality.

The agent system 102 also allows any user to create and execute computer commands in a user-friendly and time-efficient manner. For instance, the agent system 102 automatically discovers and proposes program code that satisfies a user's programming objectives, which reduces the need for the user to expend effort in manually researching viable code solutions and trying out these different solutions. These user-efficiency benefits also result in the efficient use of computing resources (e.g., processor resources, communication resources, memory resources, power, etc.). That is, the agent system 102 can produce program code with less consumption of computing resources because the agent system 102 can produce the program code in less time compared to a traditional, ad hoc, trial-and-error approach to program development. As will be described below, the agent system 102 can also incorporate various safety provisions that reduce the risk that the development of program code will result in the release of sensitive information, or that the execution of the program code will cause damage to a computing device.

FIG. 2 shows additional details regarding one implementation of the state machine system 110 of FIG. 1. As previously explained, the state machine system 110 interacts with the pattern-completion engine 108 and current context information 122 stored in memory 124. The current context information 122 includes a sequence of tokens 202, which, in turn, is made up of a first series of tokens formed by the initial context information 126 and a second sequence of tokens formed by the added context information 128. A dash 204 marks a position in the sequence of tokens 202 at which a next token is to be added by the state machine system 110. In some implementations, the state machine system 110 can clear (remove) the tokens in the added context information 128 via a clear instruction 206.

At various junctures, the state machine system 110 issues a request 208 to the pattern-completion engine 108, which requests the pattern-completion engine 108 to generate one or more new tokens, given the current context information 122. The state machine system 110 can also specify other parameters that control the prediction function performed by the pattern-completion engine 108. For example, the state machine system 110 can instruct the pattern-completion engine 108 to recursively generate text tokens until the state machine system 110 encounters a predetermined token (such as, in some contexts, the colon “:” character). The state machine system 110 can also include a temperature parameter T that governs a level of precision in which the pattern-completion engine 108 performs its function. In response to the state machine's request, the pattern-completion engine 108 generates one or more new tokens 210. The new tokens 210 may include a predetermined transition cue 212 that will cause the state machine system 110 to transition to a new mode.

FIG. 2 also shows that, at various junctures, the state machine system 110 issues a request 214 to update the current context information 122. For example, after the user mode component 114 collects new tokens from the user, the state machine system 110 adds the new tokens to the end of the sequence of tokens 202. The new tokens will include the preamble “User:” to conform to the pattern of text content reflected in the initial context information 126 (in which text associated with different modes is preceded by identifying text labels).

In some implementations, the state machine system 110 operates in a programmatic loop. Broadly, at the beginning of each dialogue pass, mode-detecting logic 216 determines whether the mode is currently undefined (e.g., because the mode has been programmatically set to “none”). If so, the mode-detecting logic 216 requests the pattern-completion engine 108 to recursively generate new tokens 210 until a predetermined stop token is found, such as the colon character. The mode-detecting logic 216 then mines the new tokens 210 to discover the particular transition cue is associated with the stop token. For example, if the new tokens 210 contain the text “{answer_mode}:” (e.g., “Alfie:”), the mode-detecting logic 216 will determine that the transition cue is “answer_mode”. In response to this finding, the mode-detecting logic 216 calls the answer mode component 116. FIG. 2 represents the selection and activation of a particular mode component using a multiplexing symbol 218.

When activated, a selected mode component will perform mode-specific actions. After these actions are completed, the state machine system 110 resets the mode to “none” and transfers control back to the mode-detecting logic 216 to begin a new cycle. A path 220 represents the above-summarized behavior. In other instances, the mode-detecting logic 216 will conclude that a mode has already been programmatically set, and therefore is not “none.” For example, per an initial setting 222, the state machine system 110 sets the mode to “user mode” prior to entering first pass of the loop. Thus, in the first pass, the mode-detecting logic 216 will forego its request to the pattern-completion engine 108 and immediately transfer control to the user mode component 114. In other instances, a mode component that has been selected in a last-completed dialogue pass will switch to another mode and then transfer control back to the mode-detecting logic 216 (forgoing the resetting of the mode to “none”). For example, the user mode component 114 can receive an input signal from the user that the user mode component 114 interprets as a request to directly transition to the command mode. A path 224 represents this alternative behavior.

In some implementations, the current context information 122 stored in the memory 124 is constrained to have no more than a maximum number M of tokens (such as a maximum of 4096 tokens in some implementations). The state machine system 110 can enforce this provision by storing new tokens in the memory 124 on a first-in-first-out (FIFO) basis. For example, when a number of tokens exceeds the preset maximum number of tokens, the state machine system 110 can delete the oldest token in the added context information 128 (e.g., a token 226 shown in FIG. 2) and add a new token to the added context information 128 (e.g., at the position of slot 204 shown in FIG. 2), leaving the initial context information 126 intact.

FIGS. 3-5 respectively show implementations of the user mode component 114, the answer mode component 116, and the command component 118. Each of these mode components implements a mode-specific flow of operations. In each case, the flow of operations is to be understood as merely one way of performing mode-specific functions, among other possible ways.

To begin with, FIG. 3 shows one implementation of the user mode component 114. When the user mode component 114 is activated, get-input logic 302 retrieves user input 304 that the user types via a keyboard, or enters via a microphone and a voice recognition system, or enters via some other input mechanism. The user input 304 includes one or more text tokens. Special input processing logic 306 determines whether the user input 304 includes any predetermined control characters. For example, if the user types a “$” character, the special instruction processing logic 306 will conclude that the user wants to directly enter a command. In response, the special input processing logic 306 will set the mode to “command mode” and return control back to the mode-detecting logic 216 of FIG. 2. The user can alternatively input a control character to delete the added context information 128, or input another control character to terminate a dialogue session. Assuming that the user does not enter one of these kinds of control characters, update-context logic 308 adds the transition cue “User:” followed by the user input 304 to the current context information 122.

FIG. 4 shows one implementation of the answer mode component 116. When the answer mode component 116 is activated, get-response logic 402 requests the pattern-completion engine 108 to generate a response, given the current context information 122, and subject to a specified stopping condition (such as the occurrence of a STOP token, or the occurrence of a transition cue for the user mode or a transition cue for the command mode, etc.). This request causes the pattern-completion engine 108 to return a response 404 that includes one or more tokens. Next, update-context logic 406 adds the transition cue “{answer mode}:” (e.g., “Alfie:”) followed by the response 404 itself to the end of the current context information 122. More specifically, note that the mode-detecting logic 216 may have activated the answer mode component 116 in response to detecting the transition cue “{answer_mode}:” (e.g., “Alfie:”) in the new tokens 210 (see FIG. 2). But no tokens are added to the current context information 122 until some component explicitly requests the tokens to be added. In the context of FIG. 4, the update-context logic 406 is the agent that adds the transition cue “{answer_mode}:” (e.g., “Alfie:”) to the current context information 122. Print logic 408 outputs the response 404 to the user, e.g., where the response 404 is displayed for the user, or converted to speech and audibly read to the user.

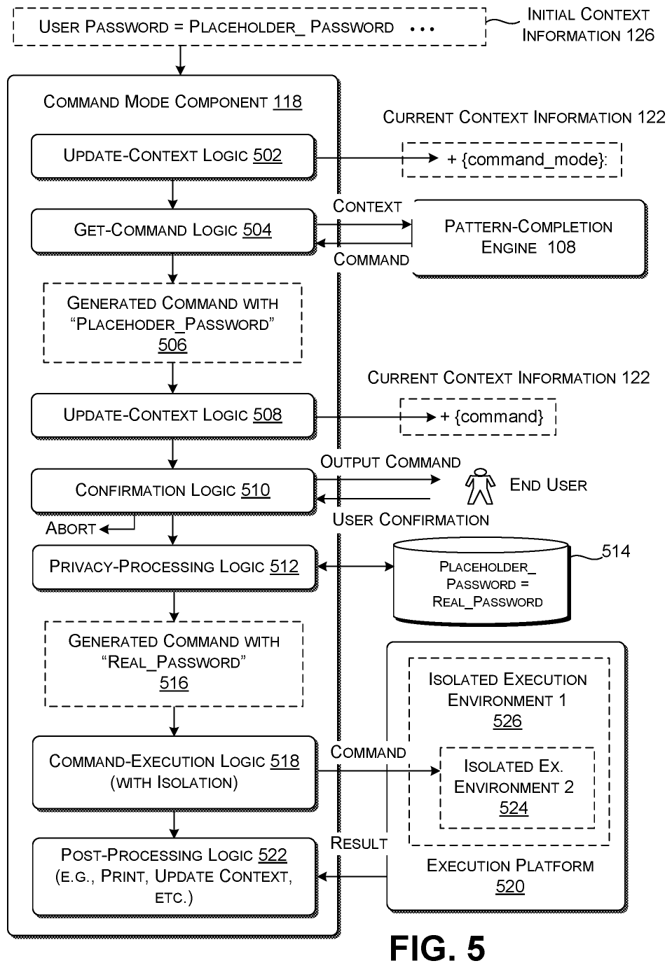

FIG. 5 shows one implementation of the command mode component 118. When this mode is activated, update-context logic 502 adds the transition cue “{command_mode}:” (e.g., “Command:”) to the current context information 122. Again, this operation may formalize a previous decision to enter the command mode, e.g., based on engine output information generated by the pattern-completion engine 108 or a mode selection decision made by another mode component in a last dialogue pass. Get-command logic 504 asks the pattern-completion engine 108 to generate a command 506, given the current context information 122 that is supplied to the pattern-completion engine 108, and given a specified stop condition (such as the occurrence of a STOP token). Another instance of update-context logic 508 adds the command 506 to the current context information 122 (whereas the prior instance of update-context logic 502 only added the preamble “{command_mode}:” (e.g., “Command:”) to the current context information 122). Adding the preamble “{command_mode}:” (e.g., “Command:”) to current context information 122 as a preliminary step is beneficial because the presence of the preamble more effectively induces the pattern-completion engine 108 to produce a command.

FIG. 5 specifically focuses on those cases in which the command 506 that is generated includes a placeholder item that serves as a surrogate for an actual sensitive-information item. A sensitive-information item contains information that the user wishes to remain private for any reason. Here, the placeholder item is the illustrative token “Placeholder_Password” that serves as a replacement for the user's actual password (which is generically referred to herein as “Real_Password”). In other cases, the command may include two or more such placeholder items. In other cases, the command 506 may include no placeholder items. The pattern-completion engine 108 knows to use the token “Placeholder_Password” instead of the user's actual password based on several clues. First, as part of the initial context information 126, the state machine system 110 receives substitution information that indicates that the developer-selected token “Placeholder_Password” is a valid substitution for any occasion in which the user's real password is needed to execute a command. Second, the initial context information 126 includes one or more dialogue examples that demonstrate the use of “Placeholder_Password” in program instructions in which the user's actual password is required. Third, the pattern-completion engine 108 has observed many program patterns in the course of the pattern-completion engine's training that strengthen its conclusion that the kind of substitution describe above is appropriate.

In some implementations, confirmation logic 510 outputs the command 506 to the user for his or her inspection. The user can instruct the confirmation logic 510 to execute the command 506 by pressing a particular key (e.g., the RETURN key). Or the user can instruct the confirmation logic 510 to abort the command by pressing another particular key (e.g., the ESCAPE key). The confirmation logic 510 will terminate its operations if the user presses the ESCAPE key.

In other implementations, the confirmation logic 510 may refrain from displaying or otherwise outputting the command 506. For example, the confirmation logic 510 can omit this display operation when the command 506 falls into a predetermined category of commands that have been a priori assessed as acceptable, e.g., based on a developer setting or a user setting. For example, the confirmation logic 510 may refrain from displaying the command 506 when the confirmation logic 510 merely seeks to interrogate a frequently-used search engine or website that has a well-established reputation for safety.

Assuming that the user presses the RETURN key, a privacy-processing logic 512 replaces any placeholder items in the command 506 with their actual sensitive-information item counterparts. For example, the privacy-processing logic 512 will substitute the token “Placeholder_Password” with the user's actual password, e.g., “Real_Password.” To perform this function, the privacy-processing logic 512 consults a store 514 that holds the user's sensitive-information items, and that establishes their mappings to respective placeholder items. For instance, the store 514 can correspond to a password locker provided by a local or online password service. As a result of its processing, the privacy-processing logic 512 produces a modified command 516 that contains “Real_Password” in place of “Placeholder_Password.” Command execution logic 518 then executes the modified command 516 on an appropriate execution platform 520, which represents one of the execution platforms 106 shown in FIG. 1.

The execution platform 520 produces a result based on the outcome of its processing of the modified command 516. For instance, the result may reflect the answer to a user's question, confirmation that an operation has been performed, the results of a requested computation, etc. In other cases, the result may indicate that the execution platform 520 encountered an error or other impediment in the course of the execution platform's processing of the modified command 516. Post-processing logic 522 presents the result to the user, e.g., by displaying the result or reading the result out. The post-processing logic 522 also adds the result to the current context information 122.

The above-described privacy provisions of the command mode component 118 reduce the chances that the user's private information will be exposed to entities in a manner deemed unacceptable to the user. For example, assume that the pattern-completion engine 108 is implemented by a remote server provided by a third-party entity. The privacy provisions described above prevent the user's private information from being sent to the remote server when the pattern-completion engine 108 is interrogated. It is true that the command execution logic 518 may use the user's private information to carry out the modified command 516. But the command execution logic 518 can use traditional safeguards in performing this operation, such as by encrypting the private information prior to sending the private information to a remote server.

The command execution logic 518 can take other actions to protect the execution platform 520 from harmful effects that may be caused by the execution of the modified command 516. For example, the command execution logic 518 can run each command in an isolated environment, such as the illustrated isolated environment 524. The command execution logic 518 can implement isolation using different technologies, e.g., through the use of a container sandbox, a virtual machine, etc. A container sandbox isolates a particular application process from other application processes. Malicious code that runs in the particular application process therefore does not affect other application processes that run in other containers. A user can abort a compromised process in a container, again without affecting other application processes that run in other containers. FIG. 5 specifically illustrates an implementation in which the command execution logic 518 produces nested container sandboxes, such that the isolated environment 524 in which the modified command 516 is run is nested in, and isolated from, an isolated environment 526 in which a preceding command is run. Isolation can be achieved in various ways, such as through namespace isolation. A virtual machine, by contrast, performs abstraction on a more inclusive level compared to containerization by using a hypervisor to create a virtual version of the operating system running on the execution platform 520 and the execution platform's underlying hardware resources. The command execution logic 518 can also provide safeguards that prevent undesired interaction with network resources, such as by preventing the model-generated code from accessing all network resources, or by preventing the model-generated code from accessing selected network resources, and/or by preventing the model-generated code from performing selected actions with respect to selected network resources (such as logging onto sensitive accounts, posting on social media, etc.). An implementation can exercise these constraints in an environment-specific manner. For example, an implementation that forbids all interaction with network resources can entirely disable network interactively. An implementation that allows only interaction with a particular search engine can block all network interaction except for addresses associated with the particular search engine.

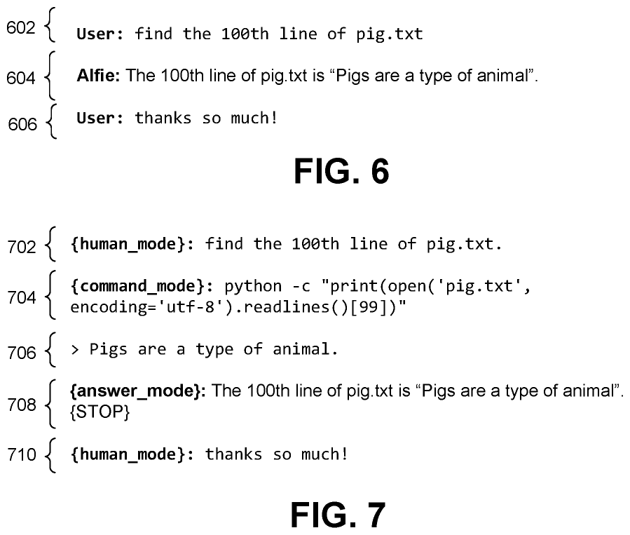

FIG. 6 shows an example of a dialogue between a user and the agent system of FIG. 1. FIG. 6 specifically shows the content that is presented to the user over the course of the dialogue. In a first dialogue segment 602, the user requests the agent system 102 to provide the 100^{th} line of a specified text. In a second dialogue segment 604, the agent system 102 provides the results of the agent system's processing of the user's request. In a third dialogue segment 606, the user thanks the agent system 102. As previously explained, note that that the agent system 102 replaces the placeholder strings “{human_mode_},” {answer_mode},” and “command_mode}” with the actual text items “User,” “Alfie,” and “Command,” respectively. This means that the pattern-completion engine 108 is fed the text items “User,” “Alfie,” and “Command,” and outputs those same text items. The output information sent to the user also includes at least the text items “User” and “Alfie.”

FIG. 7 shows illustrative messages produced by the agent system 102 of FIG. 1 for the dialogue of FIG. 6. The state machine system 110 begins by entering the user mode as a default. In a first dialogue pass 702, the user mode component 114 receives the input of the user: “find the 100th line of the pig.txt”. The user mode component 114 then adds the transition cue “{human_mode}:” (e.g., “User:”) and the user's input (“find the 100^{th} line of pig.txt”) to the current context information 122.

In a next dialogue pass 704, the mode-detecting logic 216 asks the pattern-completion engine 108 to provide predicted tokens, given the current context information 122. The pattern-completion engine 108 responds to this request by outputting a transition cue “{command_mode}:” (e.g., “Command:”). In response to detecting this cue, the mode-detecting logic 216 activates the command mode component 118. The command mode component 118 adds the transition cue {command_mode}:” (e.g., “Command:”) to the current context information 122. The command mode component 118 then requests the pattern-completion engine 108 to generate a command. In this merely illustrative case, the command mode component 118 generates a program command in the Python programming language, and adds the command to the current context information 122. The command mode component 118 then instructs an execution platform to execute the command, to produce an output result 706: “Pigs are a type of animal”. Note that, in this merely illustrative case, the command mode component 118 does not ask the user for explicit permission to perform the command. If the command mode component 118 did ask for confirmation, however, the command mode component 118 would have presented the command to the user, and then waited for the user to press the RETURN key (to accept the execution of the command) or the ESCAPE key (to abort the execution of the command mode).

In a next dialogue pass 708, the mode-detecting logic 216 activates the answer mode component 116 upon encountering the transition cue {answer_mode}:” (e.g., “Alfie:”) in the predicted tokens generated by the pattern-completion engine 108. Next, the answer mode component 116 asks the pattern-completion engine 108 to provide an answer, given the current context information 122. The answer mode component 116 then updates the context information to include the transition cue {answer_mode}:” (e.g., “Alfie:”) and the generated answer itself, and then sends the answer to the user.

In a final dialogue pass 710, the mode-detecting logic 216 activates the user mode upon encountering the transition cue {human_mode}:” (e.g., “User:”) in the predicted tokens generated by the pattern-completion engine 108. Next, the user input component 114 receives the user's input and adds the user's input to the current context information 122.

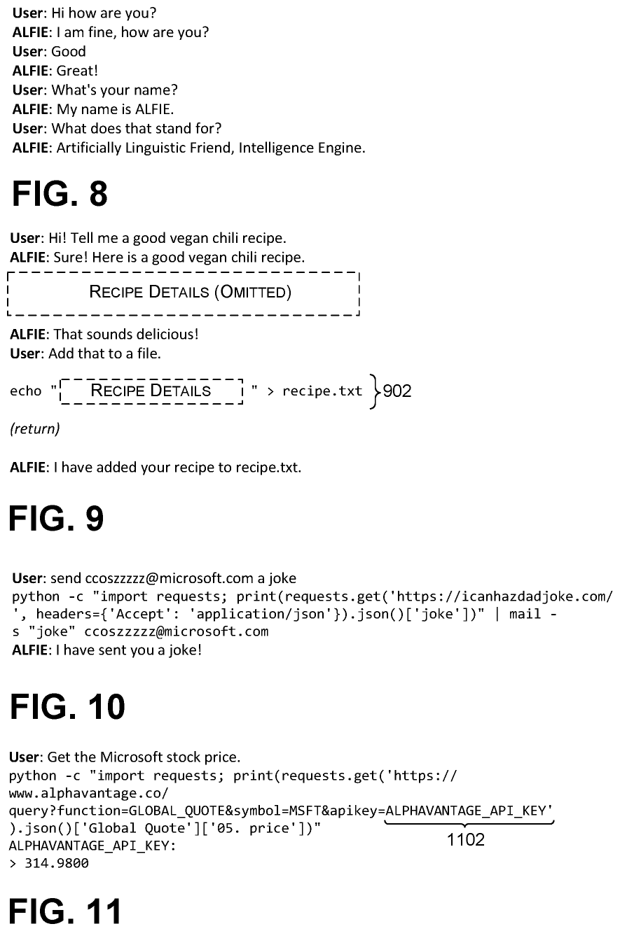

FIGS. 8-11 respectively show four other examples of dialogues between a user and the agent system 102 of FIG. 1. These four examples are intended to convey that the agent system 102 can handle a variety of different kinds of interactions. For simplicity, FIGS. 8-11 omit some of the internal signals generated by agent system 102. In the first dialogue of FIG. 8, the user and the agent system 102 engage in chitchat without executing any commands. That is, in this example, the state machine system 110 transitions between the user mode and the answer mode without entering the command mode.

In the second dialogue of FIG. 9, the user asks the agent system 102 for a good vegan chili recipe. The agent system 102 responds by finding and displaying a chili recipe (the details of which are omitted in FIG. 9). The user then asks the agent system 102 to add the recipe to a specified file, recipe.txt. Here, in message 902, the command mode component 118 displays the command that will perform the requested action, and asks the user to approve or decline the execution of the command. Upon receiving the user's confirmation, the agent system 102 provides a reply to inform the user that the requested action has been performed.

In the third dialogue of FIG. 10, the user asks the agent system 102 to send a joke to a specified email address. In response, when prompted to do so, the pattern-completion engine 108 automatically generates a two-part command that 1) retrieves a joke from a website that provides jokes, and 2) sends the joke to the specified email address. FIG. 10 shows the command that the pattern-completion engine 108 generates, which the command mode component 118 can optional present to the user for his or her confirmation. Again, the pattern-completion engine 108 is able to formulate this two-part command because the code-language model 112 has the ability to generalize based on related actions encountered in its training, even though it may never have seen an exact counterpart to the two-part command shown in FIG. 10. The third dialogue ends in the answer mode, in which the agent system 102 confirms that it has performed the requested action.

In the fourth dialogue of FIG. 11, the user asks for a stock price. In response, the command mode component 118 formulates a command that will obtain the information requested by the user. Note that the command includes a placeholder item 1102, “ALPHAVANTAGE_API_KEY”, that is a substitution for an actual sensitive-information item (corresponding to a private API key). Prior to executing this command, the command mode component 118 will replace the placeholder item 1102 with the actual private API key.

FIGS. 12 and 13 together show illustrative initial context information 126 that can be fed to the state machine system 119 of FIG. 1. The initial context information 126 includes plural representative dialogues (1202-1212 and 1302-1312). The representative dialogues (1202-1212 and 1302-1312) inform the state machine system 110 of the kinds of dialogue patterns the system machine system 110 will be asked to extend. For instance, the first representative dialogue 1202 provides an example of how the state machine system 110 is expected to handle a multi-part request. The second representative dialogue 1204 provides an example of how the state machine system 110 is expected to handle a case in which an execution platform cannot execute a command because the execution platform encounters an error condition (as reflected in line 1214). The state machine system 110 responds to this situation by generating another command (e.g., as reflected in line 1216). The second representative dialogue 1204 also provides an example of how the state machine system 110 handles the user's explicit request to provide an alternative command (as reflected in line 1218). The third representative dialogue 1206 provides an example of how the state machine system 110 produces a placeholder item in place of a corresponding sensitive-information item.

A representative dialogue 1302 in FIG. 13 shows an example in which the agent system 102 retrieves weather-related information from an online source of weather information, and then extracts selected information items from the information. The agent system 102 uses the extracted items to construct its response to the user. Another representative dialogue 1308 provides an example in which the agent system 102 cannot execute a requested mathematical operation in an execution platform because the execution platform lacks a software module that is required to perform the operation. In line 1314, the execution platform informs the agent system 102 of the reason why the execution platform cannot execute the command. The agent system 102 responds in line 1316 by using the pattern-completion engine 108 to generate a command that performs the preliminary task of acquiring the missing software module. In line 1318, the agent system 102 then regenerates the command that will perform the requested mathematical operation.

Although not shown in FIGS. 12 and 13, the initial context information 126 can also include an introductory narrative that establishes the characteristics and objectives of the agent system 102, e.g., using words and phrases such as “friendly,” “concise,” “knowledgeable about JavaScript,” etc. These words and phrases induce the agent system 102 to adopt behavior that reflects the specified characteristics. The introductory narrative can also identify the name given to the agent system 102, such as “Alfie” in the examples presented herein. This information induces the agent system 102 to refer to itself as “Alfie” in the agent system's interaction with the user. Again, the agent system 112 can adopt the characteristics conveyed in the introductory narrative due to its ability to generalize based on words and examples it has previously encountered in training. For example, a training system that produces the code-language model 112 can incorporate the concept of “friendly” into an example dialogue by moving a vector-space representation of the dialogue towards a vector-space representation of the concept of “friendly.”

Although not shown in FIGS. 12 and 13, the initial context information 126 can also include introductory information that establishes the correlation between one more placeholder items and corresponding sensitive-information items. This information provides one piece of evidence that induces the agent system 102 to use specified placeholder items in place of counterpart sensitive-information items.

FIG. 14 shows a transformer-based decoder 1402, which is one kind of neural network that can be used as the pattern-completion engine 108 of FIG. 1. The decoder 1402 includes a pipeline of stages that map a sequence of input tokens 1404 to at least one output token 1106. The decoder 1402 appends the output token 1406 to the end of the sequence of input tokens 1404, to provide an updated sequence of tokens. In a next pass, the decoder 1402 processes the updated sequence of tokens to generate a next output token. The decoder 1402 repeats the above process until the decoder 1402 generates a specified stop token, such as a colon. As used herein, a “token” or “text token” refers to a unit of text having any granularity, such as an individual word, a word fragment produced by byte pair encoding (BPE), a character n-gram, a word fragment identified by the WordPiece algorithm, etc. To facilitate explanation, assume that each token corresponds to a complete word. The WordPiece algorithm is a well-known tokenization technique described, for instance, in Wu, et al., “Google's Neural Machine Translation System: Bridging the Gap between Human and Machine Translation,” arXiv:1609.08144v2 [cs.CL], Oct. 8, 2016, 23 pages. Byte pair encoding is another tokenization technique described, for instance, in Sennrich, et al., “Neural Machine Translation of Rare Words with Subword Units,” arXiv:1508.07909v5 [cs.CL], Jun. 10, 2016, 11 pages.

The pipeline of stages includes an embedding component 1408 that maps the sequence of tokens 1404 into respective embedding vectors 1410. For example, the embedding component 1408 can produce one-hot vectors that describe the tokens, and can then map the one-hot vectors into the embedding vectors 1410 using a machine-trained linear transformation. The embedding component 1408 can then add position information to the respective embedding vectors 1410, to produce position-supplemented embedded vectors. The position information added to each embedding vector describes the embedding vector's position in the sequence of embedding vectors 1410.

A series of decoder blocks (1412, 1414, . . . , 1416) process the output of the embedding component 1408, with each decoder block receiving its input information from a preceding decoder block (if any). FIG. 14 describes a representative architecture of the first decoder block 1412. Although not shown, other decoder blocks share the same architecture as the decoder block 1412.

The decoder block 1412 includes, in order, an attention component 1418, an add-and-normalize component 1420, a feed-forward neural network (FFN) component 1422, and a second add-and-normalize component 1424. The attention component 1418 performs masked attention analysis using the following equation:

$$attn ( Q , K , V ) = softmax ( \frac{Q {K}^{T}}{\sqrt{d}} ) V . \qquad ( 1 )$$

The attention component 1418 produces query information Q by multiplying a position-supplemented embedded vector 1426 for a last-introduced token (Tₙ) in the sequence of tokens 1404 by a query weighting matrix W^{Q}. The attention component 1418 produces key information K and value information V by multiplying the position-supplemented embedding vectors associated with the entire sequence of tokens 1404 by a key weighting matrix W^{K} and a value weighting matrix W^{V}, respectively. To execute Equation (1), the attention component 1418 takes the dot product of Q with the transpose of K, and then divides the dot product by a scaling factor \sqrt{d}, to produce a scaled result The symbol d represents the dimensionality of the transformer-based decoder 1402. The attention component 1418 takes the Softmax (normalized exponential function) of the scaled result, and then multiples the result of the Softmax operation by V, to produce attention output information. More generally stated, the attention component 1418 determines the importance of each input vector under consideration with respect to every other input vector. The attention component 1418 is said to perform masked attention insofar as the attention component 1418 masks output token information that, at any given time, has not yet been determined. Background information regarding the general concept of attention is provided in above-identified paper by Vaswani, et al., “Attention Is All You Need,” in 31st Conference on Neural Information Processing Systems (NIPS 2017), 2017, 11 pages.

Note that FIG. 14 shows that the attention component 1418 is composed of plural attention heads, including a representative attention head 1428. Each attention head performs the computations specified by Equation (1), but with respect to a particular representational subspace that is different than the subspaces of the other attention heads. To accomplish this operation, the attention heads perform the computations using different respective sets of query, key, and value weight matrices. Although not shown, the attention component 1418 can concatenate the output results of the attention component's separate attention heads, and then multiply the results of this concatenation by another weight matrix W^{O}.

The add-and-normalize component 1420 includes a residual connection that combines (e.g., sums) input information fed to the attention component 1418 with the output information generated by the attention component 1418. The add-and-normalize component 1420 then performs a layer normalization operation on the output information generated by of the residual connection, e.g., by normalizing values in the output information based on the mean and standard deviation of those values. The other add-and-normalize component 1424 performs the same functions as the first-mentioned add-and-normalize component 1420.

The FFN component 1422 transforms input information to output information using a feed-forward neural network having any number of layers. In some implementations, the FFN component 1422 is a two-layer network that performs its function using the following equation:

FNN(x)=max(0,xW_{fnn1}+b₁)W_{fnn2}+b₂ (2).

The symbols W_{fnn1} and W_{fnn2} refer to the two weight matrices used by the FFN component 1422, having reciprocal shapes of (d, d_{fnn}) and (d_{fnn}, d), respectively. The symbols b₁ and b₂ represent bias values.

A Softmax component 1430 can use a combination of a linear transformation operation and the Softmax function to map output information generated by the nth decoder block 1416 into a probability distribution. The probability distribution identifies the probability associated with each token in an identified vocabulary. More specifically, the Softmax component computes the probability of a candidate token qᵢ as (exp(zᵢ/T))/(Σᵢ exp(zᵢ/T)), where zᵢ is a corresponding value in the output information generated by the nth decoder block 1416, and T is a temperature parameter that controls the precision of the Softmax function.

A token search component 1432 selects at least one token based on the probability distribution generated by the Softmax component 1430. More specifically, in a greedy search heuristic, the token search component 1432 selects the token having the highest probability for each decoder pass. In a beam search heuristic, for each decoder pass, the token search component 1432 selects a set of tokens having the highest conditional probabilities, e.g., by selecting the three tokens with the highest conditional probabilities. To compute the conditional probability of a particular token under consideration, the token search component 1432 identifies the search path through a search space that was used to reach the token under consideration. The token search component 1432 computes the conditional probability of the token under consideration based on a combination of the probabilities of the tokens along the search path. In a next pass, the transformer-based decoder 1402 applies the above-described pipeline of decoder operations to each token in the set of tokens generated by the beam search heuristic in the preceding pass.

Other implementations of the pattern-completion engine 108 can use other kinds of neural network architectures compared to the transformer-based decoder 1402 shown in FIG. 14. For instance, other implementations of the pattern-completion engine 108 can use an RNN architecture that uses a recursively-called LSTM unit. In addition, or alternatively, other implementations of the pattern-completion engine 108 can use other model paradigms to select output tokens, compared to the sequence-based model paradigm used by the transformer-based decoder 1402 of FIG. 14. For instance, other implementations can use a machine-trained ranking model to select the most likely intent expressed by the current context information 122. These implementations can then map the selected intent to one or more output tokens. Background information on the general topic of ranking models can be found in Phophalia, Ashish, “A Survey on Learning To Rank (LETOR) Approaches in Information Retrieval,” in 2011 Nirma University International Conference on Engineering, 2011, pp. 1-6.

FIG. 15 shows a first development pipeline 1502 for developing a machine-trained model for use in the pattern-completion engine 108 of FIG. 1. The development pipeline 1502 compiles a set of training examples in a data store 1504. A first subset of the training examples in the data store 1504 include natural language samples extracted from various sources, such as human-assistant dialogues, Wikipedia articles, online blogs, online news articles, reviews, website content, etc. A second subset of training examples can include code fragments selected from computer programs obtain from any source(s) of program code, such as the above-mentioned GitHub website. A fragment often includes a mixture of program instructions and commentary pertaining to the program instructions. Different programming languages use different telltale characters to designate comments, such as the # symbol in the Python programming language.

A training system 1506 produces the code-language model 1508 by performing training on the training examples in the data store 1504. In some implementations, the training system 1506 applies a training objective that successively attempts to minimize prediction errors. Consider, for instance, a particular training example that includes an incomplete sequence of tokens (T₁, T₂, . . . , T_{N}). The training system 1506 can measure a prediction error for this particular training example by comparing a predicted token (T_{N+1,model}) with a ground-truth token (T_{N+1,known}) that represents the actual token to follow the last token T_{N} in the sequence that is considered as correct. In other implementations, the training system 1506 structures its training as a reinforcement learning problem, e.g., by successively modifying a policy to increase an accumulative reward measure. The accumulative award measure is determined by summing up individual reward scores assigned to individual respective predictions, in which correct predictions receive higher individual rewards than incorrect predictions.

More specifically, in some implementations, the training system 1506 can perform training on a combined training set that includes the first subset of training examples (that contain natural language samples) and the second subset of training examples (that contain the code samples), to produce the code-language model 1508. Other implementations can perform pre-training based on the first subset of training examples, to produce a pre-trained language model. The training system 1506 can then perform further training on the pre-trained language model based on the second subset of training examples, to produce the code-language model 1508.

FIG. 16 shows a second development pipeline 1602 for developing a machine-trained model for use in the pattern-completion engine 108 of FIG. 1. The second development pipeline 1602 incorporates the same process flow as the first development pipeline 1502, e.g., by using the training system 1506 to generate the code-language model 1508 based on a corpus of training examples in the data store 1504. The training examples in the data store 1504 can include the same variety of text fragments set forth above in the description of the first development pipeline 1502.

The second development pipeline 1602 differs from the first development pipeline 1502 by including a refinement process for further training the code-language model 1508. In some implementations, the second development pipeline 1602 compiles a supplemental corpus of labeled training examples in a data store 1604. Each such training example in the data store 1604 includes a portion of program code of any size (such as a single command, a subroutine, etc.) together with a label that identifies a safety level associated with the program code. For example, a training example that includes an instruction to delete all files stored on a computer device's hard drive might be given a low score to indicate that it is very unsafe. A training example that provides an instruction to query a well-known commercial search engine may be given a high score that identifies it as safe. More generally, a score given to a training example need not be binary (safe or unsafe); other implementations, for instance, can assign a safety score to a training example in a range of scores, e.g., ranging from level 1 (very unsafe) to level 5 (very safe). In some implementation, a developer can rely on a group of human programmers to annotate the training examples with safety scores. The labels can also be derived based on decisions made by users in the course of interacting with the agent system 102. For example, if users repeatedly abort an attempt to publish certain information to a social media site, a label-generating component (not shown) can create a training example that designates the underlying command as unsafe.

A fine-tuning system 1606 can perform additional training on the code-language model 1508 based on the training examples in the data store 1604. The process of fine-tuning involves adjusted the weights of the code-language model 1508 to produce a fine-tuned code-language model 1608. More specifically, to perform fine-tuning, the fine-tuning system 1606 applies a training objective that attempts to minimize the occasions in which the pattern-completion engine 108 generates unsafe commands in the command mode.

To conclude the explanation of Section A, note that the agent system 102 can extend the principles described above in different ways. For example, other implementations of the state machine system 110 can use a different set of modes compared to the three-mode implementation described above (involving a user input mode, an answer mode, and a command mode).

In addition, or alternatively, other implementations can inject other cues into dialogues compared to the transition cues described above. For example, the pattern-completion engine 108 can be induced to insert the tag “Unsafe” or the like whenever the pattern-completion engine 108 produces a command that is considered unsafe. The command mode component 118 can use this tag to control the manner in which the command mode component 118 processes the generated command. The agent system 102 can induce the pattern-completion engine 108 to insert such a tag in the same manner described above, e.g., in part, by use of instructive examples in the initial context information 126 that use this tag to mark unsafe commands, and which demonstrate how the command mode subsequently interprets this tag.

In addition, or alternatively, other implementations can provide different configurations of the agent system 102 for different users. For example, some implementations can provide a first version of the agent system 102 for a novice user and a second version of the agent system 102 for an expert developer user. Versions can vary in different respects, e.g., by using different instances of initial context information 126, and possibly using pattern-completion engines that use different fine-tuned models.

In addition, or alternatively, other implementations can adapt the performance of the agent system 102 over the course of the agent system's use by a particular user. For example, some implementations can modify the initial context information 126 based on dialogue patterns that the user frequently invokes in his or her interaction with the agent system 102. This modification will best enable the pattern-completion engine 108 to correctly mimic the types of programming objectives and styles that the user is known to favor. Other implementations can modify the initial context information 126 based on the dialogue patterns exhibited by an identified group of users, or an entire population of users.

The above variations are set forth by way of illustration, not limitation. Other implementations can vary the structure and manner of use of the agent system 102 in other ways.

B. Illustrative Processes

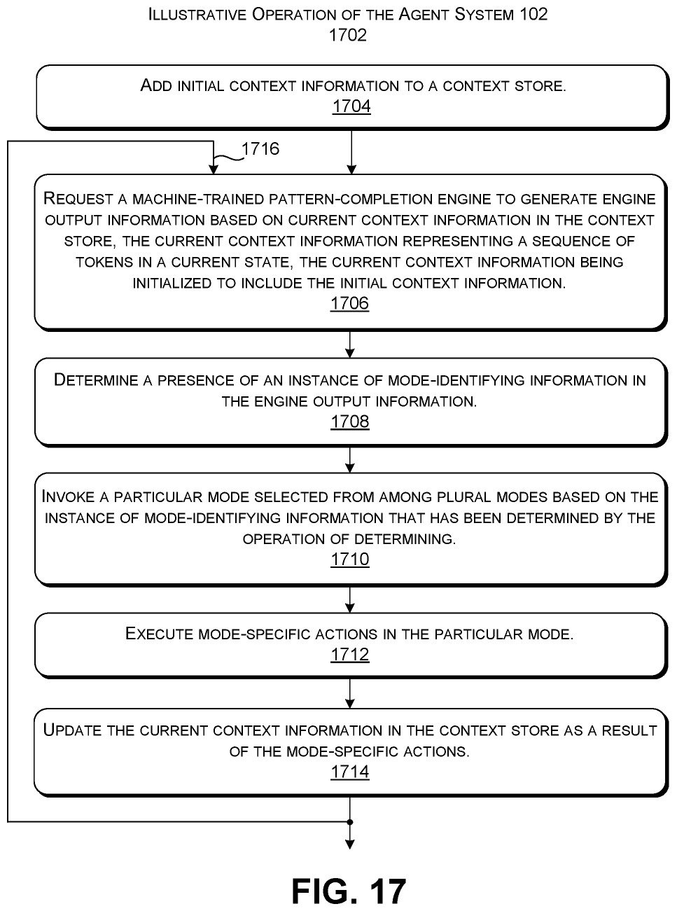

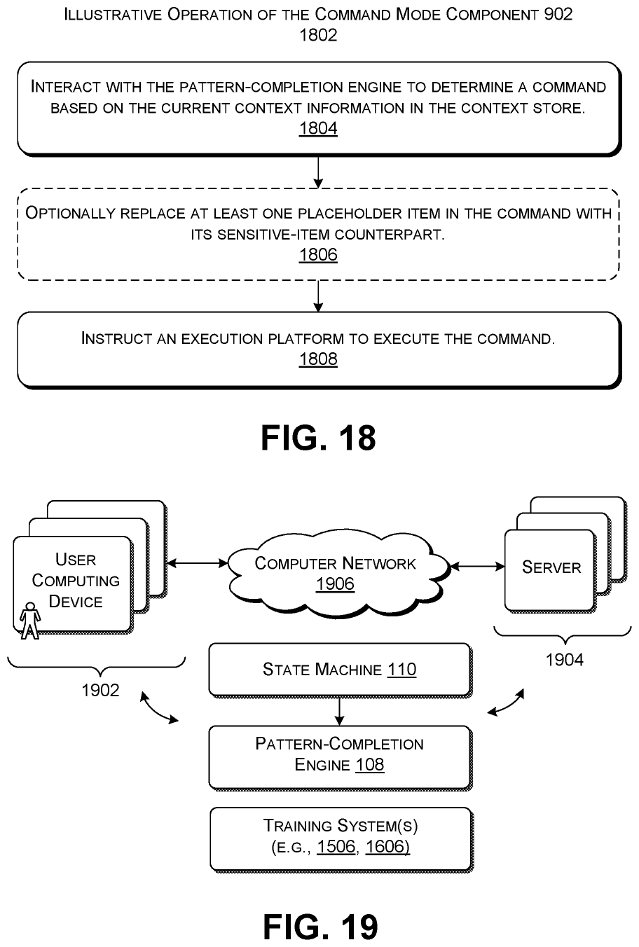

FIGS. 17 and 18 show processes that explain the operation of the agent system 102 of Section A in flowchart form, according to some implementations. Since the principles underlying the operation of the agent system 102 have already been described in Section A, certain operations will be addressed in summary fashion in this section. Each flowchart is expressed as a series of operations performed in a particular order. But the order of these operations is merely representative, and can be varied in other implementations. Further, any two or more operations described below can be performed in a parallel manner. In some implementations, the blocks shown in the flowcharts that pertain to processing-related functions are implemented by the hardware logic circuitry described in Section C, which, in turn, can be implemented by one or more hardware processors and/or other logic units that include a task-specific collection of logic gates.

FIG. 17 shows a computer-implemented process 1702 that represents one manner of operation of the agent system 102 of FIG. 1. In block 1704, the agent system 102 adds initial context information 126 to the context store (e.g., the memory 124). In block 1706, the agent system 102 requests the machine-trained pattern-completion engine 108 to generate engine output information based on current context information 122 in the context store. The current context information 122 represents a sequence of tokens 202 in a current state, and is initialized to include the initial context information 126 provided in block 706. In block 1708, the agent system 102 determines a presence of an instance of mode-identifying information in the engine output information. The agent system 102 specifically performs block 1708 when the mode is currently undetermined (e.g., set to “none”). In block 1710, the agent system 102 invokes a particular mode selected from among plural modes based on the instance of mode-identifying information that has been determined by the operation of determining, or based on a mode previously set by the state machine system 110. In block 1712, the agent system 102 executes mode-specific actions in the particular mode. In block 1714, the agent system 102 updates the current context information 122 in a context store (e.g., the memory 124) as a result of the mode-specific actions. The loop 1716 indicates that the agent system 102 repeats the above-described operations one or more times.

FIG. 18 shows a process 1802 that represents one manner of operation of the command mode component 118 of FIG. 5. In block 1804, the command mode component 118 interacts with the pattern-completion engine 108 to determine a command based on the current context information 122 in the context store. In block 1806, the command mode component 118 optionally replaces at least one placeholder item in the command with the placeholder item's sensitive-item counterpart. In block 1808, the command mode component 118 instructs an execution platform to execute the command.

C. Representative Computing Functionality

FIG. 19 shows an example of computing equipment that can be used to implement any of the systems summarized above. The computing equipment includes a set of user computing devices 1902 coupled to a set of servers 1904 via a computer network 1906. Each user computing device can correspond to any device that performs a computing function, including a desktop computing device, a laptop computing device, a handheld computing device of any type (e.g., a smartphone, a tablet-type computing device, etc.), a mixed reality device, a wearable computing device, an Internet-of-Things (IoT) device, a gaming system, and so on. The computer network 2206 can be implemented as a local area network, a wide area network (e.g., the Internet), one or more point-to-point links, or any combination thereof.

FIG. 19 also indicates that state machine system 110, the pattern-completion engine 108, and any training system (1506, 1606) can be spread across the user computing devices 1902 and/or the servers 1904 in any manner. For instance, in some cases, the agent system 102 is entirely implemented by one or more of the servers 1904. Each user can interact with the servers 1904 via a user computing device. In other cases, the agent system 102 is entirely implemented by a user computing device in local fashion, in which case no interaction with the servers 1904 is necessary. In another case, the functionality associated with the agent system 102 is distributed between the servers 1904 and each user computing device in any manner. For example, the state machine system 110 can be implemented by a user computing device, while the pattern-completion engine 108 can be implemented by one or more of the servers 1904. Although not shown in FIG. 19, the execution platforms 106 can also be implemented by any combination of local and/or remote resources.

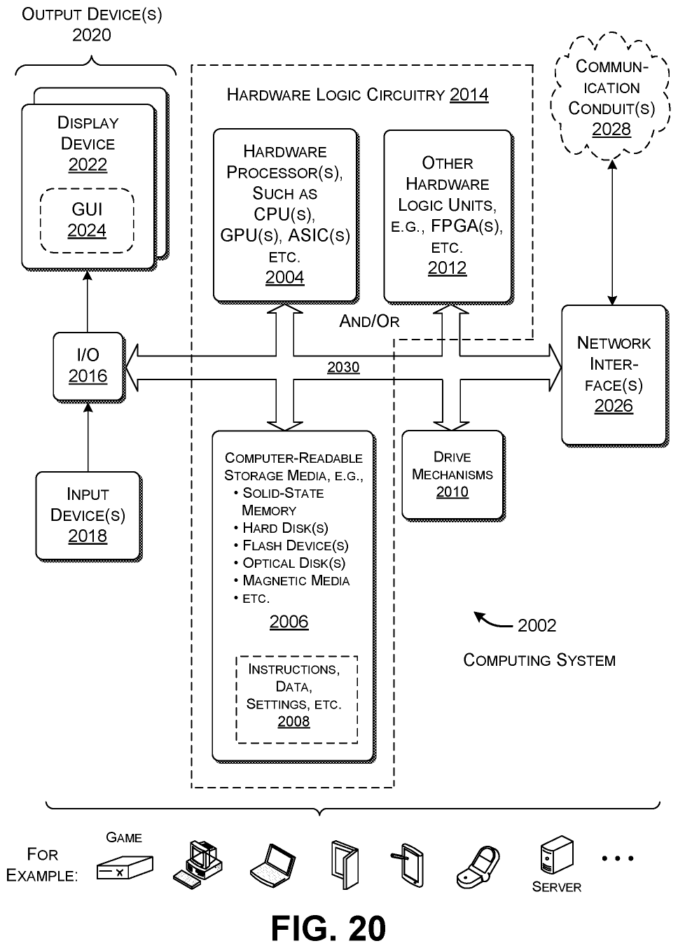

FIG. 20 shows a computing system 2002 that can be used to implement any aspect of the mechanisms set forth in the above-described figures. For instance, the type of computing system 2002 shown in FIG. 20 can be used to implement any user computing device or any server shown in FIG. 19. In all cases, the computing system 2002 represents a physical and tangible processing mechanism.

The computing system 2002 can include one or more hardware processors 2004. The hardware processor(s) 2004 can include, without limitation, one or more Central Processing Units (CPUs), and/or one or more Graphics Processing Units (GPUs), and/or one or more Application Specific Integrated Circuits (ASICs), and/or one or more Neural Processing Units (NPUs), etc. More generally, any hardware processor can correspond to a general-purpose processing unit or an application-specific processor unit.

The computing system 2002 can also include computer-readable storage media 2006, corresponding to one or more computer-readable media hardware units. The computer-readable storage media 2006 retains any kind of information 2008, such as machine-readable instructions, settings, data, etc. Without limitation, the computer-readable storage media 2006 can include one or more solid-state devices, one or more magnetic hard disks, one or more optical disks, magnetic tape, and so on. Any instance of the computer-readable storage media 2006 can use any technology for storing and retrieving information. Further, any instance of the computer-readable storage media 2006 may represent a fixed or removable unit of the computing system 2002. Further, any instance of the computer-readable storage media 2006 can provide volatile or non-volatile retention of information.

More generally, any of the storage resources described herein, or any combination of the storage resources, may be regarded as a computer-readable medium. In many cases, a computer-readable medium represents some form of physical and tangible entity. The term computer-readable medium also encompasses propagated signals, e.g., transmitted or received via a physical conduit and/or air or other wireless medium, etc. However, the specific term “computer-readable storage medium” expressly excludes propagated signals per se in transit, while including all other forms of computer-readable media.

The computing system 2002 can utilize any instance of the computer-readable storage media 2006 in different ways. For example, any instance of the computer-readable storage media 2006 may represent a hardware memory unit (such as Random Access Memory (RAM)) for storing information during execution of a program by the computing system 2002, and/or a hardware storage unit (such as a hard disk) for retaining/archiving information on a more permanent basis. In the latter case, the computing system 2002 also includes one or more drive mechanisms 2010 (such as a hard drive mechanism) for storing and retrieving information from an instance of the computer-readable storage media 2006.

The computing system 2002 can perform any of the functions described above when the hardware processor(s) 2004 carry out computer-readable instructions stored in any instance of the computer-readable storage media 2006. For instance, the computing system 2002 can carry out computer-readable instructions to perform each block of the processes described in Section B.

Alternatively, or in addition, the computing system 2002 can rely on one or more other hardware logic units 2012 to perform operations using a task-specific collection of logic gates. For instance, the hardware logic unit(s) 2012 can include a fixed configuration of hardware logic gates, e.g., that are created and set at the time of manufacture, and thereafter unalterable. Alternatively, or in addition, the other hardware logic unit(s) 2012 can include a collection of programmable hardware logic gates that can be set to perform different application-specific tasks. The latter class of devices includes, but is not limited to Programmable Array Logic Devices (PALs), Generic Array Logic Devices (GALs), Complex Programmable Logic Devices (CPLDs), Field-Programmable Gate Arrays (FPGAs), etc.

FIG. 20 generally indicates that hardware logic circuitry 2014 includes any combination of the hardware processor(s) 2004, the computer-readable storage media 2006, and/or the other hardware logic unit(s) 2012. That is, the computing system 2002 can employ any combination of the hardware processor(s) 2004 that execute machine-readable instructions provided in the computer-readable storage media 2006, and/or one or more other hardware logic unit(s) 2012 that perform operations using a fixed and/or programmable collection of hardware logic gates. More generally stated, the hardware logic circuitry 2014 corresponds to one or more hardware logic units of any type(s) that perform operations based on logic stored by the hardware logic unit(s), e.g., in the form of instructions in the computer-readable storage media and/or or instructions that form an integral part of logic gates. Further, in some contexts, each of the terms “component,” “module,” “engine,” “system,” and “tool” refers to a part of the hardware logic circuitry 2014 that performs a particular function or combination of functions.

In some cases (e.g., in the case in which the computing system 2002 represents a user computing device), the computing system 2002 also includes an input/output interface 2016 for receiving various inputs (via input devices 2018), and for providing various outputs (via output devices 2020). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers, gyroscopes, etc.), and so on. One particular output mechanism can include a display device 2022 and an associated graphical user interface presentation (GUI) 2024. The display device 2022 may correspond to a liquid crystal display device, a light-emitting diode display (LED) device, a cathode ray tube device, a projection mechanism, etc. Other output devices include a printer, one or more speakers, a haptic output mechanism, an archival mechanism (for storing output information), and so on. The computing system 2002 can also include one or more network interfaces 2026 for exchanging data with other devices via one or more communication conduits 2028. One or more communication buses 2030 communicatively couple the above-described units together.

The communication conduit(s) 2028 can be implemented in any manner, e.g., by a local area computer network, a wide area computer network (e.g., the Internet), point-to-point connections, etc., or any combination thereof. The communication conduit(s) 2028 can include any combination of hardwired links, wireless links, routers, gateway functionality, name servers, etc., governed by any protocol or combination of protocols.

FIG. 20 shows the computing system 2002 as being composed of a discrete collection of separate units. In some cases, the collection of units corresponds to discrete hardware units provided in a computing device chassis having any form factor. FIG. 20 shows illustrative form factors in its bottom portion. In other cases, the computing system 2002 can include a hardware logic unit that integrates the functions of two or more of the units shown in FIG. 1. For instance, the computing system 2002 can include a system on a chip (SoC or SOC), corresponding to an integrated circuit that combines the functions of two or more of the units shown in FIG. 20.

The following summary provides a non-exhaustive set of illustrative examples of the technology set forth herein.

(A1) According to a first aspect, some implementations of the technology described herein include a computer-implemented method (e.g., the process 1702) for assisting a user in completing a task. The method includes: adding (e.g., 1704) initial context information (e.g., 126) to a context store (e.g., memory 124); requesting (e.g., 1706) a machine-trained pattern-completion engine (e.g., 108) to generate engine output information based on current context information (e.g., 122) in the context store, the current context information representing a sequence of tokens (e.g., 202) in a current state, the current context information being initialized to include the initial context information; determining (e.g., 1708) a presence of an instance of mode-identifying information in the engine output information; invoking (e.g., 1710) a particular mode selected from among plural modes based on the instance of mode-identifying information that has been determined by the operation of determining; executing (e.g., 1712) mode-specific actions in the particular mode; and updating (e.g., 1714) the current context information in the context store as a result of the mode-specific actions. One of the plural modes is a command mode. Mode-specific actions of the command mode include interacting with the pattern-completion engine to determine a command based on the current context information in the context store, and instructing an execution platform to execute the command.

The method of A1 is implemented by an agent system that can be developed in a scalable manner, avoiding the labor-intensive, time-intensive, and error-prone process of creating and maintaining custom machine-trained models and transition tables. Further, the method of A1 provides a way for a user to quickly and safely execute computer instructions.

(A2) According to some implementations of the method of A1, the method includes repeating the operations of requesting, determining, invoking, executing, and updating one or more times. Further, the operations of requesting, determining, invoking, executing, and updating are performed by a state machine system.

(A3) According to some implementations of any of the methods of A1 or A2, the plural modes also include a user mode. A mode-specific action of the user mode includes receiving input from the user.

(A4) According to some implementations of any of the methods of A1-A3, the plural modes also include an answer mode. A mode-specific action of the answer mode includes interacting with the pattern-completion engine to determine an answer based on the current context information.

(A5) According to some implementations of any of the methods of A1-A4, the pattern-completion engine uses an auto-regressive transform-based code-language model.

(A6) According to some implementations of any of the methods of A1-A5, the initial context information includes text tokens that describe at least one characteristic of an agent system that performs the method.

(A7) According to some implementations of any of the methods of A1-A6, the initial context information includes plural dialogue examples, each dialogue example of the plural dialogue examples describing interaction that involves two or more of the plural modes.

(A8) According to some implementations of the method of A7, each dialogue example of the plural dialogue examples includes dialogue entries annotated with respective instances of mode-identifying information.

(A9) According to some implementations of any of the methods of A1-A8, the operations of requesting and determining involve requesting the prediction-completion engine to generate tokens of the engine output information until a predetermined token is detected in the engine output information.

(A10) According to some implementations of any of the methods of A1-A9, the command generated in the command mode includes a placeholder item that represents a corresponding sensitive-information item, the sensitive-information item containing information designated as private. Further, the pattern-completion engine is induced to use the placeholder item in place of the sensitive-information item based on substitution information provided in the initial context information. Further, the command-specific actions of the command mode also include replacing the placeholder item with the sensitive-information item prior to instructing the execution platform to execute the command.

(A11) According to some implementations of any of the methods of A1-A10, the command mode involves executing the command in an isolated execution environment.

(A12) According to some implementations of the method of A11, the isolated execution environment is also isolated from another isolated execution environment associated with another command that has been executed.

(A13) According to some implementations of any of the methods of A1-A12, the mode-specific actions of the command mode also include identifying the command as unsafe based on mode-identifying information generated by the prediction-completion engine that identifies the command as unsafe. Further, the pattern-completion engine is induced to generate the mode-identifying information that identifies the command as unsafe based on safety information provided in the initial context information.

(A14) According to some implementations of any of the methods of A1-A13, the operation of updating the current context information includes adding a particular instance of mode-identifying information to the current context information.

(A15) According to some implementations of any of the methods of A1-A14, the pattern-completion engine uses a code-language model that is generated by a training system based on a corpus of training examples, some of the training examples in the corpus being drawn from natural language samples, and some of the training examples in the corpus being drawn from relations between text items expressed in instances of program code. Further, the training system trains the code-language model to reduce occasions in which the code-language model, given part of a particular training example in the corpus, incorrectly completes the particular training example.

(A16) According to some implementations of method of A15, the code-language model is fine-tuned by a supplemental training system based on a supplemental corpus that includes examples of computer commands, each computer command in the supplemental corpus being given a label that identifies whether the computer command in the supplemental corpus is considered safe or unsafe. Further, the supplemental training system fine-tunes the code-language model to reduce occasions in which the code-language model, given a particular command from the supplemental corpus that is unsafe, incorrectly identifies the particular command as safe.

In yet another aspect, some implementations of the technology described herein include a computing system (e.g., computing system 2002). The computing system includes hardware logic circuitry (e.g., 2014) that is configured to perform any of the methods described herein (e.g., any of the methods of A1-A16).

In yet another aspect, some implementations of the technology described herein include a computer-readable storage medium (e.g., the computer-readable storage media 2006) for storing computer-readable instructions (e.g., information 2008). One or more hardware processors (e.g., 2004) execute the computer-readable instructions to perform any of the methods described herein (e.g., any of the methods of A1-A16).

More generally stated, any of the individual elements and steps described herein can be combined, without limitation, into any logically consistent permutation or subset. Further, any such combination can be manifested, without limitation, as a method, device, system, computer-readable storage medium, data structure, article of manufacture, graphical user interface presentation, etc. The technology can also be expressed as a series of means-plus-format elements in the claims, although this format should not be considered to be invoked unless the phase “means for” is explicitly used in the claims.

As to terminology used in this description, the phrase “configured to” encompasses various physical and tangible mechanisms for performing an identified operation. The mechanisms can be configured to perform an operation using the hardware logic circuity 2014 of Section C. The term “logic” likewise encompasses various physical and tangible mechanisms for performing a task. For instance, each processing-related operation illustrated in the flowcharts of Section B corresponds to a logic component for performing that operation.

This description may have identified one or more features as “optional,” or may have used other conditional language in the description of the feature(s). This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Further, the term “plurality” refers to two or more items, and does not necessarily imply “all” items of a particular kind, unless otherwise explicitly specified. Further, the descriptors “first,” “second,” “third,” etc. are used to distinguish among different items, and do not imply an ordering among items, unless otherwise noted. The phrase “A and/or B” means A, or B, or A and B. Further, the terms “comprising,” “including,” and “having” are open-ended terms that are used to identify at least one part of a larger whole, but not necessarily all parts of the whole. Finally, the terms “exemplary” or “illustrative” refer to one implementation among potentially many implementations.

In closing, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for assisting a user in completing a task, comprising:
adding initial context information to a context store;
requesting a machine-trained pattern-completion engine to generate engine output information based on current context information in the context store, the current context information representing a sequence of tokens in a current state, the current context information being initialized to include the initial context information;
determining a presence of an instance of mode-identifying information in the engine output information;
invoking a particular mode selected from among plural modes based on the instance of mode-identifying information that has been determined by said determining;
executing mode-specific actions in the particular mode; and
updating the current context information in the context store as a result of the mode-specific actions,
one of the plural modes being a command mode, and
mode-specific actions of the command mode including interacting with the pattern-completion engine to determine a command based on the current context information in the context store, and instructing an execution platform to execute the command.

2. The computer-implemented method of claim 1, wherein the method further includes repeating said requesting, determining, invoking, executing, and updating one or more times, and wherein said requesting, determining, invoking, executing, and updating are performed by a state machine system.

3. The computer-implemented method of claim 1, wherein the plural modes also include a user mode, and wherein a mode-specific action of the user mode includes receiving input from the user.

4. The method of claim 1, wherein the plural modes also include an answer mode, and wherein a mode-specific action of the answer mode includes interacting with the pattern-completion engine to determine an answer based on the current context information.

5. The computer-implemented method of claim 1, wherein the pattern-completion engine uses an auto-regressive transformer-based code-language model.

6. The computer-implemented method of claim 1, wherein the initial context information includes text tokens that describe at least one characteristic of an agent system that performs the method.

7. The computer-implemented method of claim 1, wherein the initial context information includes plural dialogue examples, each dialogue example of the plural dialogue examples describing interaction that involves two or more of the plural modes.

8. The computer-implemented method of claim 7, wherein said each dialogue example of the plural dialogue examples includes dialogue entries annotated with respective instances of mode-identifying information.

9. The computer-implemented method of claim 1, wherein said requesting and determining involve requesting the prediction-completion engine to generate tokens of the engine output information until a predetermined token is detected in the engine output information.

10. The computer-implemented method of claim 1,
wherein the command generated by the command mode includes a placeholder item that represents a corresponding sensitive-information item, the sensitive-information item containing information designated as private,
wherein the pattern-completion engine is induced to use the placeholder item in place of the sensitive-information item based on substitution information provided in the initial context information, and
wherein the mode-specific actions of the command mode also include replacing the placeholder item with the sensitive-information item prior to instructing the execution platform to execute the command.

11. The computer-implemented method of claim 1, wherein the mode-specific actions of the command mode also include instructing the execution platform to execute the command in an isolated execution environment.

12. The computer-implemented method of claim 11, wherein the isolated execution environment is also isolated from another isolated execution environment associated with another command that has been executed.

13. The computer-implemented method of claim 1,
wherein the mode-specific actions of the command mode also include identifying the command as unsafe based on mode-identifying information generated by the prediction-completion engine that identifies the command as unsafe, and
wherein the pattern-completion engine is induced to generate the mode-identifying information that identifies the command as unsafe based on safety information provided in the initial context information.

14. The computer-implemented method of claim 1, wherein said updating the current context information includes adding a particular instance of mode-identifying information to the current context information.

15. The computer-implemented method of claim 1,
wherein the pattern-completion engine uses a code-language model that is generated by a training system based on a corpus of training examples, some of the training examples in the corpus being drawn from natural language samples, and some of the training examples in the corpus being drawn from relations between text items expressed in instances of program code,
wherein the training system trains the code-language model to reduce occasions in which the code-language model, given part of a particular training example in the corpus, incorrectly completes the particular training example.

16. The computer-implemented method of claim 15,
wherein the code-language model is fine-tuned by a supplemental training system based on a supplemental corpus that includes examples of computer commands, each computer command in the supplemental corpus being given a label that identifies whether the computer command in the supplemental corpus is considered safe or unsafe, and
wherein the supplemental training system fine-tunes the code-language model to reduce occasions in which the code-language model, given a particular command from the supplemental corpus that is unsafe, incorrectly identifies the particular command as safe.

17. A computing system, comprising:
hardware logic circuitry configured to execute instructions provided in memory to perform state machine operations including:
adding initial context information to a context store;
requesting a machine-trained pattern-completion engine to generate engine output information based on current context information in the context store, the current context information representing a sequence of tokens in a current state, the current context information being initialized to include the initial context information;
determining a presence of an instance of mode-identifying information in the engine output information;
invoking a particular mode selected from among plural modes based on the instance of mode-identifying information that has been determined by said determining;
executing mode-specific actions in the particular mode; and
updating the current context information in the context store as a result of the mode-specific actions,
one of the plural modes being a command mode, and
mode-specific actions of the command mode including interacting with the pattern-completion engine to determine a command based on the current context information in the context store, and instructing an execution platform to execute the command.

18. The computing system of claim 17, wherein the plural modes also include a user mode, and wherein a mode-specific action of the user mode includes receiving input from the user.

19. The computing system of claim 17, wherein the plural modes also include an answer mode, and wherein a mode-specific action of the answer mode includes interacting with the pattern-completion engine to determine an answer based on the current context information.

20. A computer-readable storage medium for storing computer-readable instructions, one or more hardware processors performing a method when executing the computer-readable instructions that comprises:
adding initial context information to a context store;
requesting a machine-trained pattern-completion engine to generate engine output information based on current context information in the context store, the current context information representing a sequence of tokens in a current state, the current context information being initialized to include the initial context information;
determining a presence of an instance of mode-identifying information in the engine output information;
invoking a particular mode selected from among plural modes based on the instance of mode-identifying information that has been determined by said determining;
executing mode-specific actions in the particular mode; and
updating the current context information in the context store as a result of the mode-specific actions,
one of the plural modes being a command mode, mode-specific actions of the command mode including interacting with the pattern-completion engine to determine a command based on current context information in the context store,
another of the plural modes being a user mode, a mode-specific action of the user mode including receiving input from the user, and
another of the plural modes being an answer mode, a mode-specific action of the answer mode including interacting with the pattern-completion engine to determine an answer based on the current context information.
